(19) United States
(12) Patent Application Publication
(10) Pub. No.: US 2007/0077420 A1
(43) Pub. Date: Apr. 5, 2007

(54) Polyether aliphatic urethane film for protection of exposed surfaces

(75) Inventors: Douglas Worthen, Lowell, MA (US); Robert M. Covey, Branford, CT (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: Worthen Industries, Nashua, NH (US)

(21) Appl. No.: 11/399,303

(22) Filed: Apr. 6, 2006

Related U.S. Application Data
(60) Provisional application No. 60/723,872, filed on Oct. 5, 2005.

(51) Int. Cl. B32B 7/12

(52) U.S. Cl. 428/354

(57) ABSTRACT

A film features a base layer including an aliphatic thermoplastic urethane having substantially planar upper and lower surfaces. The upper surface includes a substantially coextensive topcoat layer while the lower surface may feature either a substantially coextensive adhesive layer (optionally with a release sheet contacting the exposed surface of the adhesive layer) or alternatively a second, substantially coextensive topcoat layer. The base layer preferably has a cross-sectional thickness of between approximately 0.0254 mm (1 mil) to approximately 5.08 mm (200.0 mil). According to one embodiment, the base layer has a cross-sectional thickness of between 0.0762 mm (3.0 mil) to approximately 0.508 mm (20.0 mil), and is particularly useful as a protective film for the exterior surfaces of objects such as automobiles, boats, houses, and the like. Alternatively, the base layer has a cross-sectional thickness of 1.016 mm (40 mil) to 5.08 mm (200.0 mil) and is particularly useful for transparent panels/windows such as automotive windows and panels for enclosures.

### CROSS-REFERENCE TO RELATED APPLICATIONS

The present application claims the benefit of U.S. Provisional Patent Application Ser. No. 60/723,872, filed on Oct. 5, 2005.

### TECHNICAL FIELD

The present invention relates to protective films and more particularly, relates to polyether aliphatic urethane films for protecting exposed surfaces.

### BACKGROUND INFORMATION

It is well known that environmental hazards (such as dirt, dust, rocks, pebbles, sand, acid, road salt, UV light, water, bird droppings, detergents, humidity, weather and the like) can damage the surfaces of automobiles, trailers, boats, airplanes, and the like. This damage can cause fading, cracking, scratching, and discoloration of the surface, especially surfaces that have been painted or coated. For example, damage to the painted metal surfaces of many automobiles and the like can lead, ultimately, to the metal surface rusting thereby resulting is even further damage that may require replacement of the surface.

Various means have been developed in an attempt to reduce this damage. For example, a common method of protecting the exposed surfaces is to apply wax. However, this method suffers from numerous well-known disadvantages. One disadvantage of waxing is that the application of wax is labor intensive and must be repeated often. Additionally, the wax only provides minimal protection against colliding materials such as sand, pebbles, and the like.

Another known method of protecting surfaces is to apply a surface protection polymer film such as the surface protection film described in U.S. Pat. No. 6,844,112 to Inoue et al., which is hereby incorporated fully by reference. The known surface protection films typically feature a polymer film having a layer of pressure-sensitive adhesive disposed on one side. These protective films are typically available in thicknesses from approximately 0.001″ (approximately 0.0254 mm) to approximately 0.125″ (approximately 3.177 mm), and in widths from approximately 6″ (approximately 152 mm) and widths up to approximately 120″ (approximately 3,048 mm).

While the polymer film may include various polymers, polyester TPU, referred to herein as simply polyester, has typically been used in automotive application. One reason for choosing polyester based films is the common belief that polyester polymers generally have improved physical properties for a given hardness compared to other polymers.

While generally effective, these polyester based protective films suffer from several disadvantages. For example, there have been problems with the moisture resistance or hydrolytic stability of these polyester-based protective films. Hydrolysis is generally accelerated by temperature and acidic conditions. It is important to note that a large application for these surface protection films is for the leading edges hoods of automobiles. Automobile hoods are often exposed to high temperatures (both from environmental causes and from the heat generated by the automobile engine during normal use) as well acid rain. As a result, polyester based surface protection films suffer from an increased vulnerability to hydrolysis. Accordingly, improved hydrolytic stability is extremely important.

A further disadvantage of the known surface protection films is that they are susceptible to bacterias, fungi, and microorganisms. This is particularly problematic when the surface protection film is applied to the surface after the surface has been exposed to the environment for a substantial amount of time. In these cases, bacteria, fungus, and the like which was already on the surface can be difficult to remove and can grow underneath the surface protective film. Additionally, bacteria, fungus, and the like (for example from birds and insects) can accumulate on the exterior surface of the surface protective film. These organisms can discolor the surface protective film and can actually break down the polyester. Additionally, chemicals used to remove these organisms can damage the surface protective film or the surrounding, unprotected areas.

Accordingly, what is needed is an improved surface protection film and method of protecting a surface. The improved surface protection film should preferably have increased resistance to hydrolysis. Moreover, the improved surface protection film should be resistant to bacterias, fungi, and microorganisms.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the following claims.

### SUMMARY

According to one embodiment, the present invention features a film comprising a base layer having substantially planar upper and lower surfaces and a layer of a top coating disposed about and substantially coextensive with the upper surface of the base layer.

The base layer includes a polyether aliphatic urethane, preferably an aliphatic thermoplastic urethane (TPU) including no more than approximately 90% by weight polytetramethylene ether gycol (PTMEG) and most preferably having between approximately 35% to approximately 55% by weight PTMEG. The base layer may have a cross-sectional thickness of between approximately 0.0254 mm (1 mil) to approximately 5.08 mm (200.0 mil) and most preferably between approximately 0.0762 mm (3.0 mil) to approximately 0.508 mm (20.0 mil) or between approximately 1.016 mm (40.0 mil) to approximately 5.08 mm (200.0 mil).

The base layer may optionally include a microbiocide, an ultraviolet stabilizer, or a filler. Additionally, the base layer includes a plurality of layers. For example, the base layer may feature an external layer of polyether aliphatic urethane having the upper surface and an inner layer having the lower surface. The inner layer may optionally include at least one material selected from the group consisting of polyethylene, polypropylene, polyester, polyamide, regenerated cellulose fibers, semi-synthetic fibers and polyethylene terephthalate. Alternatively, the inner layer may include an ultraviolet protective film or a polarized film.

The top coating may feature at least one material selected from the group consisting of acrylic resin, urethane resin, polyester resin, fluroelastomers, and ultraviolet barrier particles. The top coating preferably has a cross-sectional thickness of less than approximately 0.0762 mm (3 mil). A second layer of the top coating may be disposed about and substantially coextensive with the lower surface of the base layer.

The film may further include means for securing the film to an exterior surface of an object. For example, hydrostatic adhesion or electrostatic adhesion may be used to secure the film. In the preferred embodiment, an adhesive layer (preferably a pressure sensitive adhesive) may be disposed about and substantially coextensive with the lower surface of the base layer. The adhesive layer may be applied directly to the exterior surface of the object with the film being applied to the adhesive layer afterwards. Alternatively, the adhesive layer may be applied directly to the lower surface of the base layer prior to securing the film to the exterior surface of the object. A release layer may be disposed about and substantially coextensive with an external surface of the adhesive layer to prevent adhesion prior to application of the film.

According to another embodiment, the present invention features a method of manufacturing a protective film. The method includes forming a base layer of a polyether aliphatic urethane having a substantially planar upper and lower surface. A layer of a topcoat is applied substantially coextensive with and contacting the upper surface of the base layer. An adhesive layer may optionally be applied substantially coextensive with and contacting the lower layer of the base layer.

According to yet another embodiment, the present invention features a method of manufacturing a substantially transparent panel. The method includes forming a base layer of a polyether aliphatic urethane having a substantially planar upper and lower surface and a cross-sectional thickness of between approximately 1.016 mm (40.0 mil) to approximately 5.08 mm (200.0 mil). A first layer of a topcoat compatible with the polyether aliphatic urethane of the base layer is applied substantially coextensive with and contacting the upper surface of the base layer. Optionally, a second layer of a topcoat is applied substantially coextensive with and contacting the lower surface of the base layer. The substantially transparent panel may be secured within a frame.

### BRIEF DESCRIPTION OF THE DRAWINGS

These and other features and advantages of the present invention will be better understood by reading the following detailed description, taken together with the drawings wherein:

FIG. 1 is a sectional view of one embodiment of the film according to the present invention;

FIG. 2 is a sectional view of another embodiment of the film having a base layer including multiples layers according to the present invention;

FIG. 3 is a sectional view of a further embodiment of the film having a top coat including multiple layers according to the present invention; and

FIG. 4 is a sectional view of a further embodiment of a film having a first and a second topcoat layer disposed on an upper and lower surface of the support base.

### DETAILED DESCRIPTION OF THE PREFERRED EMBODIMENTS

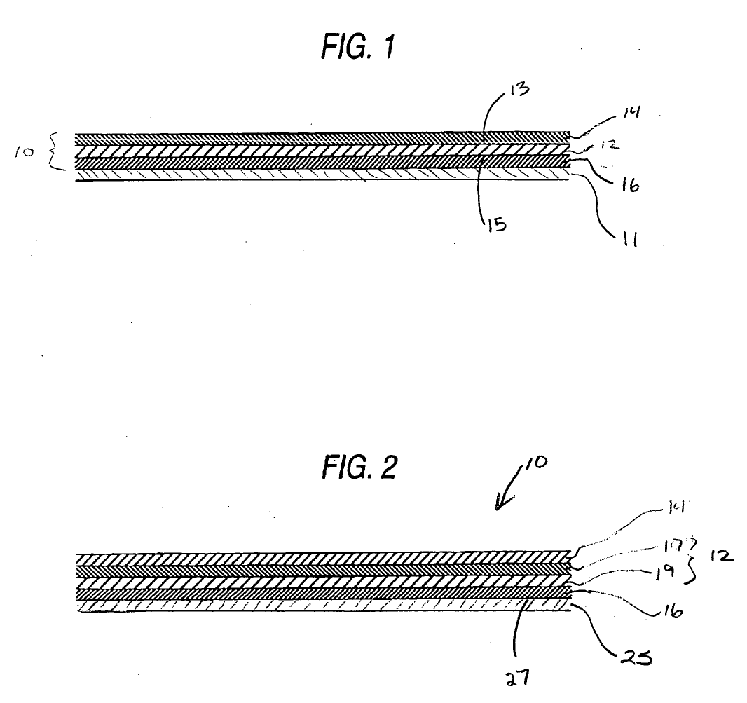

According to one embodiment, the present invention features a surface protection film 10, FIG. 1, for the protection of surfaces 11 that are exposed to environmental hazards such as, but not limited to, dirt, dust, rocks, pebbles, sand, acid, road salt, UV light, water, bird droppings, detergents, humidity, weather and the like. While not a limitation of the present invention unless otherwise specifically claimed as such, the surface protection film 10 is particularly suited for protecting the surfaces 11 of automobiles (particularly any surface/edge that is exposed to debris such as, but not limited to, hoods, rocker panels, fenders, bumpers, roofs, and the like), trailers, boats, airplanes, lights (such as headlight, foglights, or the like), sunroofs/moonroofs, vehicle windows, skylights, trains, buses, trucks, and the like. The surface protection film 10 reduces the likelihood of damage to the surface 11 that can cause fading, cracking, scratching, pitting, and discoloration of the surface 11, especially surfaces 11 that have been painted or coated.

In the exemplary embodiment, the surface protection film 10 features a base layer or film 12 having a substantially planar upper and lower surface 13, 15. In contrast to the known prior art surface protection films, which are typically constructed from polyesters, the surface protection film 10 according to the present invention includes the unexpected realization that a base layer 12 featuring a polyether aliphatic urethane provides numerous benefits over polyester based surface protection films.

As discussed above, polyesters have traditionally been chosen for use in surface protective films based on, in part, the common belief that polyester polymers generally have improved physical properties for a given hardness compared to other polymers such as polyether polymers. Additionally, polyether polymers have traditionally been used in the manufacture of laminated glass (such as bullet-proof glass) and were designed to be soft and tacky. This has lead to the widely held belief that polyether polymers would not suitable for use in surface protection films.

In direct contradiction to these generally accepted beliefs, the surface protection film 10 according to the present invention features base layer 12 of a polyether aliphatic urethane. The use of a base layer 12 of polyether aliphatic urethane results in a protective film 10 having increased moisture resistance and hydrolytic stability compared to the known surface protection film, especially those made from polyester. As discussed above, increased hydrolytic stability is particularly beneficial for applications exposed to high temperatures and acid conditions such as those commonly experienced by automobiles and boats.

Additionally, the present invention features the unexpected realization that a base layer 12 of a polyether aliphatic urethane increases ultraviolet performance of the surface protection film 10. A QUV test (using a 313B bulb, 1.1 watt/m² intensity, at a cycle of eight hours with radiation at 70° C., then four hours at 50° C. with 100% relative humidity) was conducted using the surface protection film 10 of the present invention and the prior art, polyester based films. After approximately 3 days, the surface protection film 10 of the present invention performed noticeably better than the prior art polyester based films.

Moreover, the present invention features the unexpected realization that a base layer 12 of a polyether aliphatic urethane results in a surface protection film having less gels/area compared to the prior art polyester based films. Tests were performed comparing the number of gels per area for the surface protection film 10 of the present invention and the prior art polyester based films. The results of these tests showed that the surface protection film 10 of the present invention had a significantly reduced number of gels compared to the prior art polyester based films. This reduced number of gels results in an enhanced aesthetic appearance for the surface protection film 10 according to the present invention.

A surface protection film 10 featuring a base layer 12 of polyether aliphatic urethane may also have antimicrobial, antibacterial, and/or antifungal properties. As a result, the surface protection film 10 may be less susceptible to degradation compared to the known surface protection films.

The polyether aliphatic urethane may feature any polyether aliphatic urethane known to those skilled in the art having the necessary hardness, toughness, tear strength, UV stability, haze, and light transmittance. The polyether aliphatic urethane also preferably has a sufficient optical clarity such as to not substantially change the color of the surface 11. These properties are to be determined based on the intended application of the surface protection film 10 and will vary widely based on the intended application of the surface protection film 10. Those skilled in the art will readily be able to determine these properties based on the intended application.

According to one embodiment, the base layer 12 features an aliphatic thermoplastic urethane (TPU) containing no more than approximately 90% by weight polytetramethylene ether glycol (PTMEG). As the percent weight of the PTMEG is increased, the resulting aliphatic TPU becomes softer. The exact amount of PTMEG will again depend on the intended application of the surface protection film 10 and is within the knowledge of one of ordinary skill in the art. According to the exemplary embodiment, the percent PTMEG by weight is between approximately 35% and approximately 55%.

The base layer 12 may be formed using any method known to those skilled in the art. For example, the base layer 12 may be flat die or film blown die extruded. The thickness of the base layer 12 will be determined based on the intended application of the surface protection film 10, but for illustrative purposes the base layer 12 is preferably between approximately 0.0254 mm (1 mil) to approximately 5.08 mm (200.0 mil) and most preferably between approximately 0.0762 mm (3.0 mil) to approximately 0.508 mm (20.0 mil).

It is important to note that the base layer 12 may also feature other additives and modifiers. For example, the base layer 12 may include one or more microbiocides, UV stabilizers, fillers, and/or processing additives. Additionally, surface protection film 10, FIG. 2, may feature a laminated base layer 10 having a plurality of laminated or combined layers 17, 19. According to this embodiment, the outer or external layer 17 preferably includes a layer of a polyether aliphatic urethane while the inner or layer 19 may feature any other known material such as, but not limited to, polyethylene and polypropylene and mixtures thereof, thermoplastic polymers such as polyester and polyamide, regenerated cellulose fibers or semi-synthetic fibers such as rayon, cupraammonium rayon and cellulose acetate, natural fibers such as cotton, and silk and wool, polyethylene terephthalate (PET), and mixtures thereof. Moreover, surface protection film 10 may also feature a polarized film or UV protection film.

The surface protection film 10, FIG. 1, optionally features a layer of a topcoat 14 disposed on the upper surface 13 of the base layer 12. The topcoat 14 may include any material known to those skilled in the art. In the preferred embodiment, the topcoat 14 is selected to provide additional resistance to staining, further improve moisture resistance and hydrolytic stability, and/or UV resistance. For illustrative purposes only, the topcoat 14 may include an appropriate resin (for example, but not limited to, acrylic resin, urethane resin, polyester resin, or fluroelastomers, such as polyvinylidene fluoride (PVDF) or polytetrafluoroethylene (PTFE)) and may include ultraviolet barrier particles in an appropriate medium such as an organic solvent (for example, but not limited to, toluene) or water. Alternatively, the topcoat 14 may include a commercially available coating solution such as ZE-123.υ or ZR-100.™, both of which are manufactured by Sumitomo Osaka Cement.

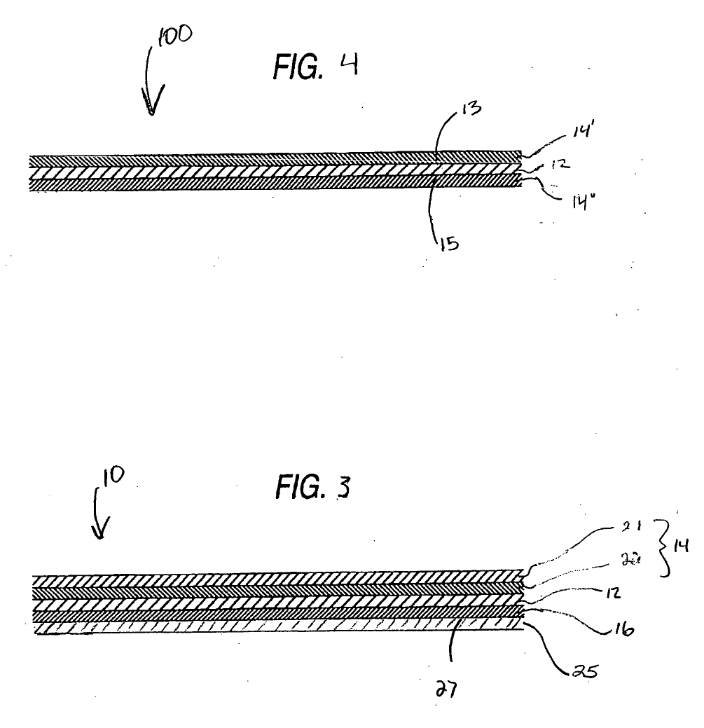

The topcoat 14 may be applied to the base layer 12 in any manner known to those skilled in the art. For example, the topcoat 14 may be applied by immersing the base layer 12 in a solution containing the topcoat 14, spraying a solution containing the topcoat 14 onto the base layer 12, or applying a solution containing the topcoat 14 to the base layer 12 by gravure coating, reverse coating, laminating, casting, co-extrusion, or by any of the methods described in U.S. Provisional Application Ser. No. 734,503, filed Nov. 8, 2005, or U.S. Provisional Ser. No. 60/734,502, filed Nov. 8, 2005, both of which are fully incorporated herein by reference. Although the thickness of the topcoat 14 may be arbitrarily determined, it is preferably 0.0762 mm (3 mil) or less. Additionally, the topcoat 14, FIG. 3, may also feature multiple layers 21, 22 of either the same or different materials.

While the surface protection film 10 could be held in to the surface 11 using hydrostatic or electrostatic adhesion or lamination, the surface protection film 10 is preferably secured to the surface 11 by way of an adhesive layer 16. According to one embodiment, the adhesive layer 16 is applied to the lower surface 15 of the base layer 12 at the factory. Alternatively, the adhesive layer 16 may be applied directly to the surface 11, and the surface protection film 10 (i.e., the base layer 12 and the topcoat 14) may then be placed on the adhesive layer 16.

In either embodiment, the adhesive layer 16 may include any adhesive known to those skilled in the art. According to the exemplary embodiment, the adhesive is a pressure sensitive adhesive, preferably an acrylic based adhesive with anti-yellowing properties. Alternatively, the adhesive layer 16 may include an appropriate rubber-based pressure-sensitive adhesive. When a rubber-based pressure-sensitive adhesive is used, it is preferable to select one comprising an aliphatic rubber polymer containing no or few unsaturated bonds, from the viewpoint of establishing a long-lasting and stable function, etc. Examples of such a rubber type polymer include polyisobutylene, butyl rubbers, A-B-A type block polymers such as styrene-ethylene/butylene copolymer-styrene (SEBS), styrene-ethylene/propylene copolymer-styrene (SEPS), styrene-butadiene-styrene (SBS) and styrene-isoprene-styrene (SIS), or hydrogenated products, and ethylene/vinyl acetate copolymer. In the exemplary embodiment, the adhesive layer 16 is preferably chosen such that the adhesive layer 16 remains secured to the base layer 12 when the surface protection film 10 is removed from the surface 11.

One or more base polymers can be used to prepare the pressure-sensitive adhesive. It is particularly preferable to use two or more base polymers having different molecular weight distribution. In the case of A-B-A type block polymers, it is preferable to use one comprising monomers having different molecular weight distribution or one having different styrene content, or to use the A-B-A type block polymers in combination with A-B type diblock polymers such as styrene-ethylene/butylene copolymer (SEB), styrene-ethylene/propylene copolymer (SEP), styrene-butadiene (SB) or styrene-isoprene (SI).

In the preparation of the pressure-sensitive adhesive, it is also possible to add appropriate tackifiers to control the adhesive characteristics thereof, etc., if needed. Examples of the tackifiers include terpene resins such as .alpha.-pinene polymers, .beta.-pinene polymers, diterpene polymer and alpha.-pinene/phenol copolymer; hydrocarbon resins such as aliphatic and aromatic resins and aliphatic and aromatic copolymers; rosin resins; coumarone and indene resins; (alkyl)phenol resins; and xylene resins. It is important to note that the examples given above are for illustrative purposes only; those skilled in the art will recognize that this list is not exhaustive and that other possibilities exist and are considered within the scope of the present invention.

Moreover, if needed, appropriate softeners suitable for the base layer 12 may be used to control the adhesive properties. Examples of these softeners include low molecular weight polyisobutylene and polybutene for the polyisobutylene, and paraffin oils for the A-B-A type block polymers. In addition, appropriate additives such as fillers, pigments, aging inhibitors and stabilizers may be used, if necessary.

The adhesive layer 16 may be applied to the lower surface 15 of the base layer 12 in any manner known to those skilled in the art. For example, the adhesive layer 16 may be applied by immersing the base layer 12 in a solution containing the adhesive layer 16, spraying a solution containing the adhesive layer 16 onto the base layer 12, or applying a solution containing the adhesive layer 16 to the base layer 12 by gravure coating, reverse coating, laminating, casting, co-extrusion, or by any of the methods described in U.S. Provisional Application Ser. No. 734,503, filed Nov. 8, 2005, or U.S. Provisional Ser. No. 60/734,502, filed Nov. 8, 2005. Although the thickness of the adhesive layer 16 may be arbitrarily determined and will vary depending on the intended application of the surface protection film 10, the adhesive layer 16 preferably ranges from between approximately 0.00254 mm (0.1 mil) to approximately 0.1016 mm (4.0 mil), preferably approximately 0.0127 mm (0.5 mil) to approximately 0.0762 mm (3.0 mil), most preferably approximately 0.0381 mm (1.5 mil). Additionally, the adhesive layer 16 may also feature multiple layers of either the same or different materials.

The surface protection film 10, FIGS. 2 and 3, may optionally include a release layer 25. The release layer 25 is preferably disposed on a lower surface 27 of the adhesive layer 16 and prevents the adhesive layer 16 from adhering to the surface protection film 10 when rolled up prior to application to the surface 11. The release sheet 25 may include any release sheet known to those skilled in the art.

According to another embodiment, the surface film 100, FIG. 4, may be used to form flexible panels, windows, tops, side coverings, and the like in place of traditional glass or polyester windows. While not an exhaustive list, the surface film 100 may be used to form flexible, substantially transparent windows and/or panels in automobiles (for example, convertible rear windows, curtains for sport utility vehicles, and the like), for porch/deck panels, boats, campers, and the like.

According to this embodiment, the surface film 100 preferably features at least one base layer 12 as described above and one or more topcoats 14 as described above. The protective film 100 according to this embodiment is preferably constructed thicker (preferably between approximately 1.016 mm (40 mil) to approximately 5.08 mm (200.0 mil)) to increase the overall strength. According to one embodiment, the surface film 100 features a single topcoat 14′, preferably disposed on the upper or top surface 13 of the base layer 12. Alternatively, the surface film 100 may also feature a second topcoat 14″ dispose on the bottom or lower surface 15 of the base layer 12. This embodiment is particularly useful in applications where both the upper and lower surfaces 13, 15 of the base layer 12 would otherwise be exposed. The surface film 100 may be secured within a framework of a canvas, vinyl, or the like by way of stitching, adhesive, ultrasonic welding, hook and loop fasteners, and the like.

Based on the above description, the film according to the present invention preferably features a base layer of polyether aliphatic urethane, and a topcoat and optionally includes an adhesive layer. The use of a base layer of polyether aliphatic urethane provides the unexpected benefits of improved moisture resistance and hydrolytic stability, and/or microorganisms, despite the widely held belief that polyether aliphatic urethane was unsuitable for use as a protective film.

As mentioned above, the present invention is not intended to be limited to a system or method which must satisfy one or more of any stated or implied object or feature of the invention and should not be limited to the preferred, exemplary, or primary embodiment(s) described herein. The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as is suited to the particular use contemplated. All such modifications and variations are within the scope of the invention as determined by the claims when interpreted in accordance with breadth to which they are fairly, legally and equitably entitled.

The invention claimed is:

1. A surface protection system for protecting an exterior surface of an object, said surface protection system comprising:
a base layer having substantially planar upper and lower surfaces with a cross-sectional thickness of between approximately 0.0762 mm (3.0 mil) to approximately 0.508 mm (20.0 mil), said base layer including a polyether aliphatic urethane;
a layer of a topcoat disposed about and substantially coextensive with said upper surface of said base layer, said topcoat being compatible with said polyether aliphatic urethane of said base layer; and
an adhesive layer substantially coextensive with and contacting said lower layer of said base layer.

2. The surface protection system as claimed in claim 1 wherein said base layer includes an aliphatic thermoplastic urethane (TPU) including no more than approximately 90% by weight polytetramethylene ether gycol (PTMEG).

3. The surface protection system as claimed in claim 2 wherein said base layer includes between approximately 35% to approximately 55% by weight PTMEG.

4. The surface protection system as claimed in claim 3 wherein said adhesive layer includes a layer of a pressure sensitive adhesive.

5. The surface protection system as claimed in claim 4 wherein said pressure sensitive adhesive is compatible with said PTMEG of said base layer.

6. A surface protection system for protecting an exterior surface of an object, said surface protection system comprising:
a base layer having substantially planar upper and lower surfaces with a cross-sectional thickness of between approximately 0.0762 mm (3.0 mil) to approximately 0.508 mm (20.0 mil), said base layer including a polyether aliphatic urethane;
a layer of a top coating disposed about and substantially coextensive with said upper surface of said base layer; and
means for securing said lower surface of said surface protection system to said exterior surface of said object.

7. The surface protection system as claimed in claim 6 wherein said base layer includes an aliphatic thermoplastic urethane (TPU) including no more than approximately 90% by weight polytetramethylene ether gycol (PTMEG).

8. The surface protection system as claimed in claim 7 wherein said base layer includes between approximately 35% to approximately 55% by weight PTMEG.

9. The surface protection system as claimed in claim 6 wherein said means for securing said film includes an adhesive layer disposed about and substantially coextensive with said lower surface of said base layer.

10. The surface protection system as claimed in claim 9 further including a release layer disposed about and substantially coextensive with an external surface of said adhesive layer.

11. The surface protection system as claimed in claim 9 wherein said adhesive layer includes a pressure sensitive adhesive.

12. The surface protection system as claimed in claim 6 wherein said means for securing said film includes hydrostatic adhesion.

13. The surface protection system as claimed in claim 6 wherein said means for securing said film includes electrostatic adhesion.

14. The surface protection system as claimed in claim 6 wherein said means for securing said film includes lamination directly onto said exterior surface of said object.

15. The surface protection system as claimed in claim 6 wherein said base layer further includes an ultraviolet stabilizer.

16. The surface protection system as claimed in claim 6 wherein said base layer includes a plurality of layers.

17. The surface protection system as claimed in claim 16 wherein said plurality of layers include an external layer having said upper surface and an inner layer having said lower surface, wherein said external layer includes said polyether aliphatic urethane.

18. The surface protection system as claimed in claim 17 where said inner layer includes at least one material selected from the group consisting of polyethylene, polypropylene, polyester, polyamide, regenerated cellulose fibers, semi-synthetic fibers, and polyethylene terephthalate.

19. A method of manufacturing a protective film comprising the acts of:
forming a base layer of a polyether aliphatic urethane having a substantially planar upper and lower surface and a cross-sectional thickness of between approximately 0.0762 mm (3.0 mil) to approximately 0.508 mm (20.0 mil);
applying a layer of a topcoat compatible with said polyether aliphatic urethane of said base layer substantially coextensive with and contacting said upper surface of said base layer; and
applying an adhesive layer substantially coextensive with and contacting said lower layer of said base layer.

20. The method as claimed in claim 19 wherein said act of forming said base layer further includes forming said base layer having a first layer with said upper surface and at least a second layer with said lower surface, wherein at least said first layer includes said polyether aliphatic urethane.

21. The method as claimed in claim 20 wherein said second layer includes at least one material selected from the group consisting of polyethylene, polypropylene, polyester, polyamide, regenerated cellulose fibers, semi-synthetic fibers and polyethylene terephthalate.

22. The method as claimed in claim 19 further including the act of applying a release layer to an exposed surface of said adhesive layer.

23. The method as claimed in claim 19 wherein said act of forming said base layer further forming said base layer of an aliphatic thermoplastic urethane (TPU) including no more than approximately 90% by weight polytetramethylene ether gycol (PTMEG).

24. The method as claimed in claim 23 further including forming said base layer with between approximately 35% to approximately 55% by weight PTMEG.

25. A method of manufacturing a substantially transparent panel comprising the acts of:
forming a base layer of a polyether aliphatic urethane having a substantially planar upper and lower surface and a cross-sectional thickness of between approximately 1.016 mm (40.0 mil) to approximately 5.08 mm (200.0 mil); and
applying a fist layer of a topcoat compatible with said polyether aliphatic urethane of said base layer substantially coextensive with and contacting said upper surface of said base layer.

26. The method as claimed in claim 25 wherein said act of forming said base layer further forming said base layer of an aliphatic thermoplastic urethane (TPU) including no more than approximately 90% by weight polytetramethylene ether gycol (PTMEG).

27. The method as claimed in claim 26 further including forming said base layer with between approximately 35% to approximately 55% by weight PTMEG.

28. The method as claimed in claim 27 further including the act of applying a second layer of a topcoat substantially coextensive with and contacting said lower surface of said base layer.

29. The method as claimed in claim 25 further including the act of securing said substantially transparent panel within a frame.

30. A film comprising:
a base layer having substantially planar upper and lower surfaces, said base layer including a polyether aliphatic urethane; and
a layer of a top coating disposed about and substantially coextensive with said upper surface of said base layer.

31. The film as claimed in claim 30 wherein said base layer has a cross-sectional thickness of between approximately 0.0254 mm (1.0 mil) to approximately 5.08 mm (200.0 mil).

32. The film as claimed in claim 31 wherein said cross-sectional thickness is between approximately 0.0762 mm (3.0 mil) to approximately 0.508 mm (20.0 mil).

33. The film as claimed in claim 31 wherein said cross-sectional thickness is between approximately 1.016 mm (40.0 mil) to approximately 5.08 mm (200.0 mil).

34. The film as claimed in claim 30 wherein said base layer includes an aliphatic thermoplastic urethane (TPU) including no more than approximately 90% by weight polytetramethylene ether gycol (PTMEG).

35. The film as claimed in claim 34 wherein said base layer includes between approximately 35% to approximately 55% by weight PTMEG.

36. The film as claimed in claim 30 wherein said base layer further includes a microbiocide.

37. The film as claimed in claim 30 wherein said base layer further includes an ultraviolet stabilizer.

38. The film as claimed in claim 30 wherein said base layer further includes a filler.

39. The film as claimed in claim 30 wherein said base layer includes a plurality of layers.

40. The film as claimed in claim 39 wherein said plurality of layers are laminated.

41. The film as claimed in claim 39 wherein said plurality of layers include an external layer having said upper surface and an inner layer having said lower surface, wherein said external layer includes said polyether aliphatic urethane.

42. The film as claimed in claim 41 where said inner layer includes at least one material selected from the group consisting of polyethylene, polypropylene, polyester, polyamide, regenerated cellulose fibers, semi-synthetic fibers and polyethylene terephthalate.

43. The film as claimed in claim 41 wherein said inner layer includes an ultraviolet protective film.

44. The film as claimed in claim 41 wherein said inner layer includes a polarized film.

45. The film as claimed in claim 30 wherein said top coating includes at least one material selected from the group consisting of acrylic resin, urethane resin, polyester resin, fluroelastomers, and ultraviolet barrier particles.

46. The film as claimed in claim 30 wherein said layer of said top coating has a cross-sectional thickness of less than approximately 0.0762 mm (3.0 mil).

47. The film as claimed in claim 30 further including at least a second layer disposed about and substantially coextensive with said lower surface of said base layer.

48. The film as claimed in claim 30 further including means for securing said film to an exterior surface of an object.

49. The film as claimed in claim 48 wherein said means for securing said film includes an adhesive layer disposed about and substantially coextensive with said lower surface of said base layer.

50. The film as claimed in claim 49 wherein said adhesive layer is applied directly to said exterior surface of said object and said film is then applied to said adhesive layer.

51. The film as claimed in claim 50 wherein said adhesive layer is applied directly to said lower surface of said base layer prior to securing said film to said exterior surface of said object.

52. The film as claimed in claim 51 further including a release layer disposed about and substantially coextensive with an external surface of said adhesive layer.

53. The film as claimed in claim 49 wherein said adhesive layer includes a pressure sensitive adhesive.

54. The film as claimed in claim 48 wherein said means for securing said film includes hydrostatic adhesion.

55. The film as claimed in claim 48 wherein said means for securing said film includes electrostatic adhesion.

56. A film comprising:
a base layer having substantially planar upper and lower surfaces, said base layer including a polyether aliphatic urethane; and
an adhesive layer applied directly to and substantially coextensive with said lower surface of said base layer.

57. The film as claimed in claim 56 wherein said adhesive layer includes a pressure sensitive adhesive.

58. The film as claimed in claim 57 further including a release layer applied directly to and substantially coextensive with an external surface of said adhesive layer.

59. The film as claimed in claim 56 wherein said base layer has a cross-sectional thickness of between approximately 0.0254 mm (1.0 mil) to approximately 5.08 mm (200.0 mil).

60. The film as claimed in claim 59 wherein said cross-sectional thickness is between approximately 0.0762 mm (3.0 mil) to approximately 0.508 mm (20.0 mil).

61. The film as claimed in claim 59 wherein said cross-sectional thickness is between approximately 1.016 mm (40.0 mil) to approximately 5.08 mm (200.0 mil).

62. The film as claimed in claim 56 wherein said base layer includes an aliphatic thermoplastic urethane (TPU) including no more than approximately 90% by weight polytetramethylene ether gycol (PTMEG).

63. The film as claimed in claim 62 wherein said base layer includes between approximately 35% to approximately 55% by weight PTMEG.

64. The film as claimed in claim 56 wherein said base layer further includes a microbiocide.

65. The film as claimed in claim 56 wherein said base layer further includes an ultraviolet stabilizer.

66. The film as claimed in claim 56 wherein said base layer further includes a filler.

67. The film as claimed in claim 56 wherein said base layer includes a plurality of layers.

68. The film as claimed in claim 67 wherein said plurality of layers are laminated.

69. The film as claimed in claim 67 wherein said plurality of layers include an external layer having said upper surface and an inner layer having said lower surface, wherein said external layer includes said polyether aliphatic urethane.

70. The film as claimed in claim 69 where said inner layer includes at least one material selected from the group consisting of polyethylene, polypropylene, polyester, polyamide, regenerated cellulose fibers, semi-synthetic fibers and polyethylene terephthalate.

71. The film as claimed in claim 69 wherein said inner layer includes an ultraviolet protective film.

72. The film as claimed in claim 69 wherein said inner layer includes a polarized film.

73. The film as claimed in claim 56 further including a layer of a top coating disposed about and substantially coextensive with said upper surface of said base layer.

74. The film as claimed in claim 73 wherein said top coating includes at least one material selected from the group consisting of acrylic resin, urethane resin, polyester resin, fluroelastomers, and ultraviolet barrier particles.

75. The film as claimed in claim 73 wherein said layer of said top coating has a cross-sectional thickness of less than approximately 0.0762 mm (3.0 mil).

76. The film as claimed in claim 73 further including at least a second layer disposed about and substantially coextensive with said lower surface of said base layer.
